(19) United States
(12) Patent Application Publication
(10) Pub. No.: US 2011/0240279 A1
(43) Pub. Date: Oct. 6, 2011

(54) HYBRID LIQUID METAL-SOLDER THERMAL INTERFACE

(75) Inventors: BRUCE K. Furman, Poughquag, NY (US); Paul A. Lauro, Brewster, NY (US); Yves C. Martin, Ossining, NY (US); Robert L. Sandstrom, Chestnut Ridge, NY (US); Da-Yuan Shih, Poughkeepsie, NY (US); Theodore G. Van Kessel, Millbrook, NY (US)

(73) Assignee: International Business Machines Corporation, Armonk, NY (US)

(21) Appl. No.: 12/750,258

(22) Filed: Mar. 30, 2010

(51) Int. Cl. F28F 21/08; B32B 15/01; B23K 35/02; B32B 15/04

(52) U.S. Cl. 165/185; 428/615; 428/576; 428/642; 428/645; 428/646; 428/672; 428/673

(57) ABSTRACT

The present invention is hybrid liquid metal-solder thermal interface. In one embodiment, a thermal interface for coupling a heat generating device to a heat sink includes a first metal interface layer, a second metal interface layer, and an isolation layer positioned between the first metal interface layer and the second metal interface layer, where at least one of the first metal interface layer and the second metal interface layer comprises a liquid metal.

### FIELD OF THE INVENTION

The present invention relates generally to the cooling of semiconductor devices, and relates more particularly to the cooling of integrated circuit (IC) chips including microprocessors.

### BACKGROUND OF THE INVENTION

Recent years have seen an evolution toward higher-power microprocessor, graphics, communication and memory semiconductor chips. This evolution in turn has driven interest in highly conductive liquid metal thermal interface (LMTI) and solder thermal interface (STI) materials to provide thermal coupling between chips and heat sinks. High concentration photovoltaics have also emerged with high-performance cooling requirements.

There are several considerations for which to account in constructing a thermal interface. First, LMTI and STI materials tend to best fulfill their purpose when they form a continuous thermal connection between the semiconductor heat source (e.g., an IC chip) and the heat sink materials. Second, semiconductor materials tend to have low coefficients of thermal expansion (CTE) and are brittle, while heat sink materials tend to have large CTEs. At high power densities and temperatures, and over many power cycles, this CTE mismatch can cause creep, voiding, pumpout, and cracking in the thermal interface materials, as well as cracking in the semiconductor materials.

Third, it is sometimes desirable to electrically isolate the semiconductor heat source from the heat sink and other cooling system components. Fourth, it is desirable to have a thermal interface solution that can be practically assembled and re-worked. For instance, assembly in the case of vapor chambers should generally avoid high temperature reflow processes typical of solder joining. Re-work described the process whereby the semiconductor heat source is removed from the heat sink for repair or replacement of either component or to allow access to the system in general. If re-work is to be done in the field, high temperatures and complex process steps are generally precluded.

### SUMMARY OF THE INVENTION

The present invention is hybrid liquid metal-solder thermal interface. In one embodiment, a thermal interface for coupling a heat generating device to a heat sink includes a first metal interface layer, a second metal interface layer, and an isolation layer positioned between the first metal interface layer and the second metal interface layer, where at least one of the first metal interface layer and the second metal interface layer comprises a liquid metal.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross sectional view of a heat sink assembly using a hybrid liquid metal-solder thermal interface, according to a first embodiment of the present invention;

FIG. 2 is a cross sectional view of a heat sink assembly using a hybrid liquid metal-solder thermal interface, according to a second embodiment of the present invention; and

FIG. 3 is a cross sectional view of a heat sink assembly using a hybrid liquid metal-solder thermal interface, according to a third embodiment of the present invention.

To facilitate understanding, identical reference numerals have been used, where possible, to designate identical elements that are common to the figures.

### DETAILED DESCRIPTION

In one embodiment, the present invention is a hybrid liquid metal-solder thermal interface for use in dissipating heat from heat-generating devices (e.g., microprocessor chips). Embodiments of the invention include at least two metal interface layers, where at least one of the metal interface layers comprises a liquid metal, and one of the metal interface layers may comprise a solder material. Embodiments of the present invention provide improved heat transfer from a heat generating device to a heat sink, thereby allowing for better heat dissipation from the heat generating device. This ultimately results in better performance of the heat generating device, as heat-related failures are minimized. Although embodiments of the present invention will be described within the context of heat generating devices and heat sinks, those skilled in the art will appreciate that the thermal interface described herein is universal in that it may be used to facilitate thermal contact between any two. solid materials or surfaces.

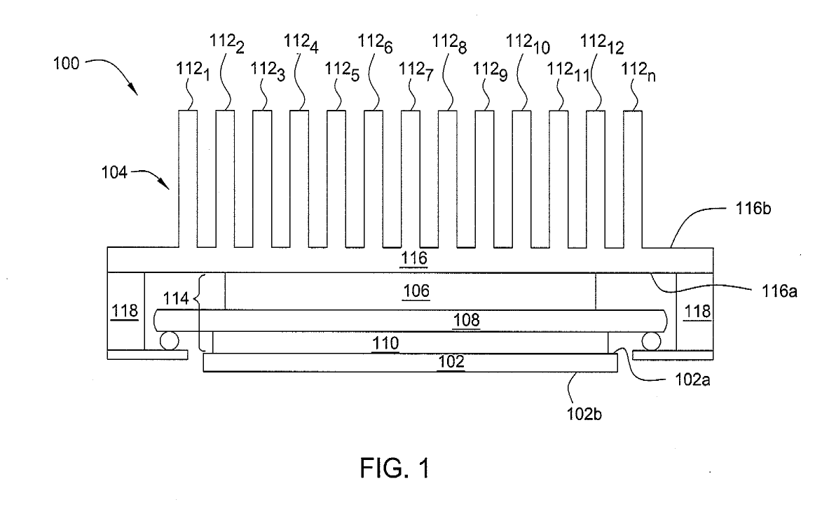

FIG. 1 is a cross sectional view of a heat sink assembly 100 using a hybrid liquid metal-solder thermal interface 114, according to a first embodiment of the present invention. As illustrated, the heat sink assembly 100 comprises the thermal interface 114 disposed between at least one heat generating device 102 (e.g., a microprocessor chip or a lidded chip) and a heat sink 104. Alternatively, the heat sink 104 may be a lid where the heat generating device 102 is a microprocessor or semiconductor chip.

The heat sink 104 comprises a base 116 having first surface 116a and a second surface 116b. In one embodiment, the heat sink 104 comprises at least one of: a vapor chamber, a heat pipe or a liquid cooler. The first surface 116a of the base 116 is relatively flat and is configured to contact the thermal interface 114. In one embodiment, the second surface 116b of the base 116 is also relatively flat and comprises a plurality of fins 112₁-112ₙ (hereinafter collectively referred to as “fins 112”) coupled thereto. The fins 112 are positioned in a substantially perpendicular orientation relative to the base 116.

The heat generating device 102 also comprises a first surface 102a and a second surface 102b. In one embodiment, both the first surface 102a and the second surface 102b of the heat generating device 102 are relatively flat. In one embodiment, the heat generating device 102 is a silicon microprocessor chip.

In one embodiment, the thermal interface 114 comprises three principal layers: a liquid metal layer 106, an isolation layer 108, and a solder layer 110. In one embodiment, all of the liquid metal layer 106, the isolation layer 108, and the solder layer 110 are thermally conductive.

The liquid metal layer 106 is coupled directly to the first surface 116a of the heat sink's base 116. In one embodiment, one or more coatings are applied to the heat sink 104 in order to provide electrical connection, wetting, isolation, and/or corrosion resistance with respect to the liquid metal layer 106. The liquid metal layer 106 comprises a metal or metal alloy that enters the liquid phase at some point during operation of the heat generating device, but may enter the solid state for a period of time or under certain operational conditions (e.g., when the heat load is low or zero). In one embodiment, the liquid metal layer 106 comprises a eutectic alloy formed of at least one of the following materials: gallium, indium, tin, lead, bismuth, silver, gold, or antimony. In one particular embodiment, the liquid metal layer 106 comprises a combination of gallium, indium, and tin.

The isolation layer 108 is thermally connected to the heat sink 104 by the liquid metal layer 106. The isolation layer 108 provides at least one of the following to the heat sink assembly 100: mechanical support, electrical isolation, support for interconnects, and moisture isolation. The isolation layer 108 comprises a layer of material (e.g., metal or ceramic) that is chosen such that the isolation layer's coefficient of thermal expansion is close to the heat generating device's coefficient of thermal expansion. In a further embodiment, the material making up the isolation layer 108 is chosen to account for additional requirements of thermal conductivity, electrical isolation, and/or mechanical support. In one embodiment, the isolation layer 108 comprises at least one of: an aluminum nitride sheet, copper, stainless steel, iron, nickel, chrome, aluminum oxide, silicon, silicon nitride, and titanium carbide. In a further embodiment, the isolation layer 108 includes a patterned copper layer on at least one surface that adds electrically and thermally conductive paths. In one embodiment, one or more coatings are applied to the isolation layer 108 in order to provide electrical connection, wetting, isolation, and/or corrosion resistance with respect to the liquid metal layer 106 and the solder layer 110.

The solder layer 110 attaches the isolation layer 108 to the first surface 102a of the heat generating device 102; thus, the heat generating device 102 is solder-attached to the isolation layer 108. The solder layer 110 comprises a layer of metal or metal alloy that is solid under normal use, but is melted for the purposes of manufacture. This includes low-melt solder materials that partially or completely melt at normal chip operating temperatures but may solidify at room temperature. In one embodiment, the solder layer 110 is expected to remain in solid form during operation of the heat generating device. In one embodiment, the solder layer 110 is formed from at least one of the following materials: lead, tin, gallium, indium, bismuth, silver, and antimony.

In one embodiment, one or more coatings are applied to the heat generating device 102 in order to provide electrical connection, wetting, isolation, and/or corrosion resistance with respect to the solder layer 110. In one embodiment, these coatings comprise at least one layer of at least one of: titanium, tungsten, tantalum, chrome, nickel, gold, silver, platinum, or palladium.

In one embodiment, the heat sink assembly 100 further comprises a gasket 118 that isolates the liquid metal layer 106 from moisture and prevents corrosion. In further embodiments, the gasket is supplemented with or replaced by a seal or desiccant.

In one embodiment, where the heat generating device 102 is a semiconductor, the first surface 102a of the heat generating device 102 is solder-bonded to a sheet of material forming the isolation layer 108, and the sheet of material contains electrically conductive coatings such that the solder bonding forms both a thermal and an electrical connection between the heat generating device 102 and the isolation layer 108.

In one embodiment, where the heat generating device 102 is a semiconductor, the first surface 102a of the heat generating device 102 is solder-bonded to a sheet of material forming the isolation layer 108, and the sheet of material contains electrically conductive coatings such that the solder bonding forms both a thermal and an electrical connection between the heat generating device 102 and the isolation layer 108. In one embodiment, these coatings comprise at least one layer of at least one of: titanium, tungsten, tantalum, chrome, nickel, gold, silver, platinum, or palladium.

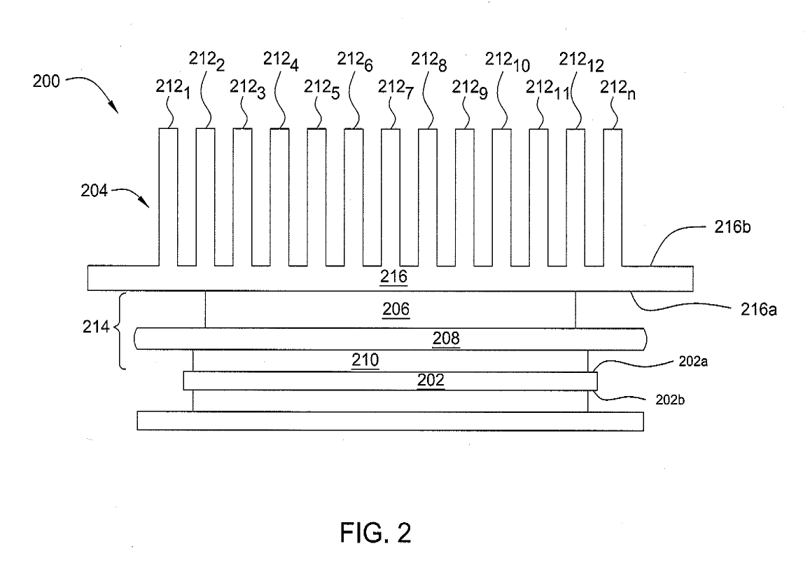

FIG. 2 is a cross sectional view of a heat sink assembly 200 using a hybrid liquid metal-solder thermal interface 214, according to a second embodiment of the present invention. The heat sink assembly 200 is substantially similar to the heat sink assembly 100 illustrated in FIG. 1. However, where the heat sink assembly 100 uses a solder layer 110 to thermally and mechanically attach the heat generating device 102 to the isolation layer 108, the heat sink assembly 200 uses a liquid metal layer 210 to thermally attach the heat generating device 202 to the isolation layer 208. Details of this embodiment are discussed in further detail below.

As illustrated, the heat sink assembly 200 comprises the thermal interface 214 disposed between at least one heat generating device 202 (e.g., a microprocessor chip or a lidded chip) and a heat sink 204. Alternatively, the heat sink 204 may be a lid where the heat generating device 202 is a microprocessor or semiconductor chip.

The heat sink 204 comprises a base 216 having first surface 216a and a second surface 216b. In one embodiment, the heat sink 204 comprises at least one of: a vapor chamber, a heat pipe or a liquid cooler. The first surface 216a of the base 216 is relatively flat and is configured to contact the thermal interface 214. In one embodiment, the second surface 216b of the base 216 is also relatively flat and comprises a plurality of fins 212₁-212ₙ (hereinafter collectively referred to as “fins 212”) coupled thereto. The fins 212 are positioned in a substantially perpendicular orientation relative to the base 216.

The heat generating device 202 also comprises a first surface 202a and a second surface 202b. In one embodiment, both the first surface 202a and the second surface 202b of the heat generating device 202 are relatively flat. In one embodiment, the heat generating device 202 is a silicon microprocessor chip.

In one embodiment, the thermal interface 214 comprises three principal layers: a solder layer 206, an isolation layer 208, and a liquid metal layer 210. In one embodiment, all of the solder layer 206, the isolation layer 208, and the liquid metal layer 210 are thermally conductive.

The solder layer 206 is coupled directly to the first surface 216a of the heat sink's base 216. The solder layer 206 comprises a layer of metal or metal alloy that is solid under normal use, but is melted for the purposes of manufacture. This includes low-melt solder materials that partially or completely melt at normal chip operating temperatures but may solidify at room temperature. In one embodiment, the solder layer 206 is expected to remain in solid form during operation of the heat generating device. In one embodiment, the solder layer 206 is formed from at least one of the following materials: lead, tin, gallium, indium, bismuth, silver, and antimony.

The isolation layer 208 is thermally connected to the heat sink 204 by the solder layer 206; thus, the heat sink 204 is solder-attached to the isolation layer 208. The isolation layer 208 provides at least one of the following to the heat sink assembly 200: mechanical support, electrical isolation, support for interconnects, and moisture isolation. The isolation layer 208 comprises a layer of material (e.g., metal or ceramic) that is chosen such that the isolation layer's coefficient of thermal expansion is close to the heat sink's coefficient of thermal expansion. In a further embodiment, the material making up the isolation layer 208 is chosen to account for additional requirements of thermal conductivity, electrical isolation, and/or mechanical support. In one embodiment, the isolation layer 208 comprises at least one of: an aluminum nitride sheet, copper, stainless steel, iron, nickel, chrome, aluminum oxide, silicon, silicon nitride, and titanium carbide. In a further embodiment, the isolation layer 208 includes a patterned copper layer on at least one surface that adds electrically and thermally conductive paths. In one embodiment, one or more coatings are applied to the isolation layer 208 and/or to the heat sink 204 in order to provide electrical connection, wetting, isolation, and/or corrosion resistance.

The liquid metal layer 210 is coupled directly to the heat generating device 202. In one embodiment, one or more coatings are applied to the heat generating device 202 in order to provide electrical connection, wetting, isolation, and/or corrosion resistance with respect to the liquid metal layer 210. The liquid metal layer 210 comprises a metal or metal alloy that enters the liquid phase at some point during operation of the heat generating device, but may enter the solid state for a period of time or under certain operational conditions(e.g., when the heat load is low or zero). In one embodiment, the liquid metal layer 210 comprises a eutectic alloy formed of at least one of the following materials: gallium, indium, tin, lead, bismuth, silver, gold, or antimony. In one particular embodiment, the liquid metal layer 210 comprises a combination of gallium, indium, and tin. In one embodiment, these coatings comprise at least one layer of at least one of: titanium, tungsten, tantalum, chrome, nickel, gold, silver, platinum, or palladium.

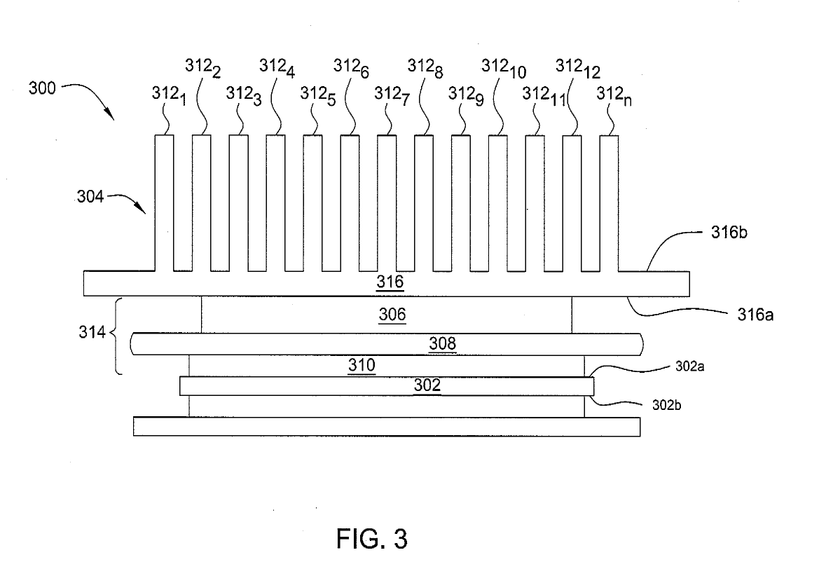

FIG. 3 is a cross sectional view of a heat sink assembly 300 using a hybrid liquid metal-solder thermal interface 314, according to a third embodiment of the present invention. The heat sink assembly 300 is substantially similar to the heat sink assemblies 100 and 200 illustrated in FIGS. 1 and 2. However, where the heat sink assemblies 100 and 200 use a single liquid metal layer (106 or 210, respectively) connected to either the heat sink or the heat generating device (104 or 202, respectively), the heat sink assembly 300 uses two liquid metal layers 306 and 310, where one of the liquid metal layers 306 and 310 is connected to each of the heat sink 304 and the heat generating device 302. Details of this embodiment are discussed in further detail below.

As illustrated, the heat sink assembly 300 comprises the thermal interface 314 disposed between at least one heat generating device 302 (e.g., a microprocessor chip or a lidded chip) and a heat sink 304. Alternatively, the heat sink 304 may be a lid where the heat generating device 302 is a microprocessor or semiconductor chip.

The heat sink 304 comprises a base 316 having first surface 316a and a second surface 316b. In one embodiment, the heat sink 304 comprises at least one of: a vapor chamber, a heat pipe or a liquid cooler. The first surface 316a of the base 316 is relatively flat and is configured to contact the thermal interface 314. In one embodiment, the second surface 316b of the base 316 is also relatively flat and comprises a plurality of fins 312₁-312ₙ (hereinafter collectively referred to as “fins 312”) coupled thereto. The fins 312 are positioned in a substantially perpendicular orientation relative to the base 316.

The heat generating device 302 also comprises a first surface 302a and a second surface 302b. In one embodiment, both the first surface 302a and the second surface 302b of the heat generating device 302 are relatively flat. In one embodiment, the heat generating device 302 is a silicon microprocessor chip.

In one embodiment, the thermal interface 314 comprises three principal layers: a first liquid metal layer 306, an isolation layer 308, and a second liquid metal layer 310. In one embodiment, all of the first liquid metal layer 306, the isolation layer 308, and the second liquid metal layer 310 are thermally conductive.

The first liquid metal layer 306 is coupled directly to the first surface 316a of the heat sink's base 316. In one embodiment, one or more coatings are applied to the heat sink 304 in order to provide electrical connection, wetting, isolation, and/or corrosion resistance with respect to the first liquid metal layer 306. The first liquid metal layer 306 comprises a metal or metal alloy that enters the liquid phase at some point during operation of the heat generating device, but may enter the solid state for a period of time or under certain operational conditions (e.g., when the heat load is low or zero). In one embodiment, the first liquid metal layer 306 comprises a eutectic alloy formed of at least one of the following materials: gallium, indium, tin, lead, bismuth, silver, gold, or antimony. In one particular embodiment, the first liquid metal layer 306 comprises a combination of gallium, indium, and tin.

The isolation layer 308 is thermally connected to the heat sink 304 by the first liquid metal layer 306. The isolation layer 308 provides at least one of the following to the heat sink assembly 300: mechanical support, electrical isolation, support for interconnects, and moisture isolation. In one embodiment, the isolation layer 308 comprises a layer of material (e.g., metal or ceramic) that is chosen to account for requirements of thermal expansion, thermal conductivity, electrical isolation, and/or mechanical support. Latitude exists in choosing the isolation layer material, since liquid metal on both sides allows the free expansion of the heat generating device 302, isolation layer 308, and heat sink 304 with little or no lateral stress.

In one embodiment, the isolation layer 308 comprises at least one of: an aluminum nitride sheet, copper, stainless steel, iron, nickel, chrome, aluminum oxide, silicon, silicon nitride, and titanium carbide. In a further embodiment, the isolation layer 308 includes a patterned copper layer on at least one surface that adds electrically and thermally conductive paths. In one embodiment, one or more coatings are applied to the isolation layer 308 in order to provide electrical connection, wetting, isolation, and/or corrosion resistance with respect to the first liquid metal layer 306 and the second liquid metal layer 310. The isolation layer 308 is mechanically constrained by the heat generating device 302 on one side and the heat sink 304 on the other side. In one embodiment, the isolation layer 308 is further mechanically constrained by supplemental means (e.g., tabs or recesses on the heat sink 304, screws, or the like).

The second liquid metal layer 310 is coupled directly to the heat generating device 302. In one embodiment, one or more coatings are applied to the heat generating device 302 in order to provide electrical connection, wetting, isolation, and/or corrosion resistance with respect to the second liquid metal layer 310. The second liquid metal layer 310 comprises a metal or metal alloy that enters the liquid phase at some point during operation of the heat generating device, but may enter the solid state for a period of time or under certain operational conditions (e.g., when the heat load is low or zero). In one embodiment, the second liquid metal layer 310 comprises a eutectic alloy formed of at least one of the following materials: gallium, indium, tin, lead, bismuth, silver, gold, or antimony. In one particular embodiment, the second liquid metal layer 310 comprises a combination of gallium, indium, and tin.

As discussed above, some surfaces of a heat sink assembly configured in accordance with the present invention may be coated for electrical connection, wetting, isolation, and/or corrosion resistance purposes. Because the materials used for the solder and/or liquid metal layers can attack or diffuse into other metals (including common heat sink materials such as aluminum or copper) or can fail to wet to other materials (including silicon, silicon dioxide, aluminum nitride, or glass), it is helpful in some embodiments to provide coatings to prevented-wetting and/or degradation of the interfaces between the thermal interface materials, the isolation layer, and the heat sink or heat generating device. De-wetting and interface degradation may cause local hot spots that degrade the performance or cause failure of the heat generating device.

In one embodiment, at least one surface of the heat sink, the isolation layer, or the heat-generating device is plated or vacuum coated with at least one of: titanium, tantalum, vanadium, nickel, silver, or chrome. In a further embodiment, the plated or vacuum coated layer is capped with gold to provide adhesion, wetting, and barrier properties.

In one embodiment, the heat generating device is vacuum coated with at least one of: chrome, nickel, gold, and titanium.

The specific materials used for such coatings are chosen to be appropriate to the solder or liquid metal with which the coated surface will come in contact. In one embodiment, the coatings are formed at least partially of a layer of titanium and gold. In one embodiment, such a coating is formed by first sputtering a layer of titanium (e.g., approximately one thousand Angstroms thick) and then sputtering a layer of gold (e.g., approximately five hundred Angstroms thick) over the layer or titanium to prevent oxide formation. This results in a wettable coating that isolates the solder or liquid metal from the coated surface. In further embodiments, coatings are formed of at least one of the following: molybdenum, nickel, chrome, tantalum, tungsten, copper, palladium, ruthenium, platinum, silver, or aluminum.

Although the above embodiments each describe one heat generating device attached to one isolation layer attached to one heat sink, it will be appreciated that alternative embodiments of the present invention may include a plurality of heat generating device attached to a single isolation layer and a single heat sink or a plurality of heat generating devices attached to a plurality of isolation layers attached to a single heat sink. Moreover, in any of the above embodiments, a gasket or seal may be used to protect the liquid metal, the solder, or both from moisture and/or to contain or isolate the liquid metal from adjacent components.

While foregoing is directed to the preferred embodiment of the present invention, other and further embodiments of the invention may be devised without departing from the basic scope thereof, and the scope thereof is determined by the claims that follow.

1. A thermal interface for coupling a heat generating device to a heat sink, the thermal interface comprising:
a first metal interface layer;
a second metal interface layer; and
an isolation layer positioned between the first metal interface layer and the second metal interface layer,
wherein at least one of the first metal interface layer and the second metal interface layer comprises a liquid metal.

2. The thermal interface of claim 1, wherein both of the first metal interface layer and the second metal interface layer comprise a liquid metal.

3. The thermal interface of claim 1, wherein the liquid metal comprises a metal or metal alloy that enters a liquid phase at temperatures encountered during operation of the heat generating device.

4. The thermal interface of claim 1, wherein the liquid metal comprises at least one of: gallium, indium, tin, lead, bismuth, silver, gold, or antimony.

5. The thermal interface of claim 1, wherein the liquid metal comprises an alloy of gallium, indium, and tin.

6. The thermal interface of claim 1, wherein one of the first metal interface layer and the second metal interface layer comprises a solder.

7. The thermal interface of claim 6, wherein the solder comprises a metal or metal alloy that melts at least partially at temperatures encountered during operation of the heat generating device.

8. The thermal interface of claim 6, wherein the solder comprises a metal or metal alloy that remains in a solid phase at temperatures encountered during operation of the heat generating device.

9. The thermal interface of claim 6, wherein the solder comprises at least one of:
lead, tin, gallium, indium, bismuth, silver, and antimony.

10. The thermal interface of claim 1, wherein the isolation layer comprises at least one of: copper, stainless steel, iron, nickel, chrome, aluminum oxide, aluminum nitride, silicon, silicon nitride, or titanium carbide.

11. The thermal interface of claim 1, wherein the isolation layer comprises an aluminum nitride sheet.

12. The thermal interface of claim 1, wherein the isolation layer comprises a patterned copper layer on at least one surface of the isolation layer.

13. The thermal interface of claim 1, wherein the isolation layer comprises a coating that provides at least one of: electrical connection, wetting, isolation, or corrosion resistance.

14. A system for dissipating heat from a heat generating device, the system comprising:
the heat generating device;
a heat sink configured to dissipate heat from the heat generating device; and
a thermal interface positioned between the heat generating device and the heat sink, for thermally coupling the heat generating device to the heat sink, where the thermal interface comprises:
a first metal interface layer coupled to a first surface of the heat sink;
a second metal interface layer coupled to a first surface of the heat generating device; and
an isolation layer positioned between the first metal interface layer and the second metal interface layer,
wherein at least one of the first metal interface layer and the second metal interface layer comprises a liquid metal.

15. The system of claim 14, wherein the liquid metal comprises a combination of gallium, indium, and tin.

16. The system of claim 14, wherein one of the first metal interface layer and the second metal interface layer comprises a solder.

17. The system of claim 16, wherein the solder comprises at least one of: lead, tin, gallium, indium, bismuth, silver, and antimony.

18. The system of claim 14, wherein the isolation layer comprises at least one of:
copper, stainless steel, iron, nickel, chrome, aluminum oxide, aluminum nitride, silicon, silicon nitride, or titanium carbide.

19. The system of claim 14, wherein at least the first surface of the heat sink comprises a coating, the coating comprising:
a layer of titanium plated or vacuum coated onto the first surface of the heat sink; and
a layer of gold capping the layer of titanium.

20. The system of claim 14, wherein at least the first surface of the heat generating device comprises a coating, the coating comprising at least one of: chrome, nickel, gold, and titanium.
